(19) United States
(12) Patent Application Publication
(10) Pub. No.: US 2008/0166530 A1
(43) Pub. Date: Jul. 10, 2008

(54) MULTI-LAYER COATING METHOD, AND PLANOGRAPHIC PRINTING PLATE AND MANUFACTURING METHOD THEREOF

(75) Inventors: Kenji HAYASHI, Haibara-gun (JP); Manabu HASHIGAYA, Haibara-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 11/965,273

(22) Filed: Dec. 27, 2007

(30) Foreign Application Priority Data
Dec. 27, 2006 (JP) 2006-353110
Feb. 7, 2007 (JP) 2007-028456

(51) Int. Cl. G03C 5/08; B05D 1/36

(52) U.S. Cl. 428/195.1; 427/402

(57) ABSTRACT

A sequential multi-layer coating method comprises: applying a photosensitive layer protection layer (A) L1 with a rod coating device onto a continuously traveling web; and applying a photosensitive layer protection layer (B) L2 with an extrusion coating device, wherein W/[U(γ1−γ2)]≧0.018 . . . (A1) is satisfied when W (cc/m²) represents a wet coating amount of the photosensitive layer protection layer (B) L2; U (m/min.) represents a traveling speed of the web; γ1 (mN/m) represents a dynamic surface tension of the photosensitive layer protection layer (B) L2; and γ2 (mN/m) represents a static surface tension of the photosensitive layer protection layer (A) L1. This method provides stable coating without coating defects such as poor coating, liquid repellency and coating streak when a non-contact coater is used as a coating device for the upper layer to conduct sequential multi-layer coating.

### BACKGROUND OF THE INVENTION

1. Field of the Invention

The present invention relates to a multi-layer coating method, and a planographic printing plate and a manufacturing method thereof. More particularly, the present invention relates to a multi-layer coating method for forming a plurality of layers in a stack on a continuously traveling strip-shaped web, and a method for manufacturing a planographic printing plate using the multi-layer coating method and a planographic printing plate.

2. Description of the Related Art

For example, a planographic printing plate is generally manufactured by: manufacturing a web as a support for a planographic printing plate by graining one surface or both surfaces of a strip-shaped aluminum plate by an ordinary method; conducting a pre-treatment such as anodic oxide film treatment on the grained surface of the web; and conducting multi-layer coating for applying a plurality of coating liquids in a stack on the web (see Japanese Patent Application Laid-Open No. 2004-223456, for example).

Exemplary cases of multi-layer coating of coating liquids include: a case wherein a photosensitive layer A (lower layer) is applied to a web and other photosensitive layer B (upper layer) is applied on the lower layer while the lower layer is undried (wet condition wherein a coating liquid has a solid content of 60% or less); a case wherein a photosensitive layer (lower layer) is applied, and a photosensitive layer protection layer (upper layer) is applied on the photosensitive layer while the photosensitive layer is undried; and a case wherein a photosensitive layer is applied and dried, and a photosensitive layer protection layer A is applied and a photosensitive layer protection layer B is applied in a multi-layered manner on the protection layer A while the protection layer is undried.

Further, as a coating method for multi-layer coating of a plurality of layers, sequential multi-layer coating and simultaneous multi-layer coating are used. The sequential multi-layer coating is a method wherein lower and upper layers are sequentially applied with individual coating devices. Exemplary upper layer coating devices include an extrusion coater, a slide bead coater and a slide curtain coater. Such coating device generally utilizes a non-contact coating system wherein a predetermined clearance between the lower layer and a tip end of a coating device is provided to prevent contact therebetween (see Japanese Patent Application Laid-Open Nos. 2004-223456 and 59-189967, for example).

In contrast, the simultaneous multi-layer coating is a system wherein a plurality of coating liquids are extruded from a plurality of slits to a slide surface, the extruded liquids are multi-layered, and the multi-layered liquids are flown down on to be applied from the tip end of the slide surface onto a web. Exemplary devices for such coating include a slide bead coater and a slide curtain coater.

The above-described sequential multi-layer coating or simultaneous multi-layer coating is adopted not only for the production of a planographic printing plate, but also for production lines including coating processes for various coating products such as photographic sensitive material and magnetic recording media.

### SUMMARY OF THE INVENTION

However, when a non-contact coating device is used as an upper layer coating device for sequential multi-layer coating as described above, there may occur coating defects such as poor coating and liquid repellency wherein an upper layer is not applied on a lower layer well, and the formation of coating streak on a coating surface of a manufactured planographic printing plate.

On the other hand, in the case of simultaneous multi-layer coating conducted by a slide bead coater or a slide curtain coater as described above, when a multi-layered liquid having a lower layer coating liquid and an upper layer coating liquid stacked flows down on a slide surface, the multi-layered liquid has an unstable flow condition. This may cause flow unevenness or liquid repellency on the slide surface, resulting in coating defects.

The above-described coating defects that occur during sequential multi-layer coating and simultaneous multi-layer coating tend to occur in high-speed coating wherein a web has a traveling speed of 60 m/min. or more or in thin film coating wherein the total coating amount of a plurality of layers is 50 cc/m² or less in a wet condition.

In view of the above situations, the present invention has been attained. A first object of the present invention is to provide: a multi-layer coating method, which enables stable coating without coating defects such as poor coating, liquid repellency and coating streak when sequential multi-layer coating of a plurality of layers is conducted by using a non-contact coater as an upper layer coating device; and a method for manufacturing a planographic printing plate using the multi-layer coating method and a planographic printing plate.

Further, a second object is to provide: a multi-layer coating method, which, when simultaneous multi-layer coating of a plurality of layers is conducted by using a coating device with a slide surface, can prevent flow unevenness and liquid repellency on the slide surface thereby to prevent coating defects; and a method for manufacturing a planographic printing plate using the multi-layer coating method and a planographic printing plate.

The present inventors found that, in sequential multi-layer coating for forming two or more layer by applying an upper layer with a second coating device on a lower layer applied with a first coating device while the lower layer is undried, when a non-contact coating device is used as the second coating device for multi-layer coating of the plurality of layers, it is important to define liquid property values of upper and lower layer coating liquids by surface tension difference and/or viscosity difference in the relation between a set coating amount W and a coating speed U. It is especially important in the case of high-speed coating at 60 m/min. or more or thin film coating wherein the total coating amount of a plurality of layers is 50 cc/m² or less in a wet condition.

More specifically, when the liquid property values of liquids is defined by surface tension, the occurrence of coating defects such as poor coating, liquid repellency and coating streak can be remarkably inhibited by controlling (i) four factors, a static surface tension of the lower layer, a dynamic surface tension of the upper layer, a wet coating amount of an upper-side layer and a traveling speed of the web, within a predetermined relation. An important point is that it is necessary to define the upper layer surface tension by a dynamic surface tension. If an upper layer coating liquid has a liquid property that increase a surface tension in an unstable flow condition at a boundary between lower and upper layers in a practical coating though it has a smaller surface tension (static surface tension) measured in a laboratory, coating defects easily occur. Thus, if the upper layer surface tension is defined by a static surface tension, a surface tension difference between lower and upper layers cannot be correctly obtained.

In addition to the above (i), when the viscosity of coating liquid is defined, the present inventor found that coating defects such as poor coating, liquid repellency and coating streak can be remarkably prevented by controlling (ii) six factors, a viscosity of the lower layer, a viscosity of the upper layer, a static surface tension of the lower layer, a dynamic surface tension of the upper layer, a wet coating amount of an upper-side layer and a traveling speed of the web, within a predetermined relation.

Therefore, the multi-layer coating method of the present invention can provide coating with good surface quality from the beginning to the end of the coating.

The present inventors also found that satisfaction of the relation among the above four factors can prevent flow unevenness and liquid repellency from occurring on a slide surface not only in the above sequential multi-layer coating but also in a simultaneous multi-layer coating method for applying two or more plural layers with a slide bead type or slide curtain type coating device having a slide surface. The present invention has been achieved based on the above findings.

In order to achieve the above object, a first aspect of the present invention provides a multi-layer coating method for sequentially forming two or more layers by: applying a lower layer onto a continuously traveling web with a first coating device; and applying an upper layer on the lower layer with a second coating device while the lower layer is undried, wherein a non-contact coating system for applying an upper layer coating liquid in a non-contact state with the lower layer is used as the second coating device, and the following equation (A1) is satisfied,

W/[U(γ1−γ2)]≧0.018 (A1)

wherein W (cc/m²) represents a wet coating amount of the upper layer; U (m/min.) represents a traveling speed of the web; γ1 (mN/m) represents a dynamic surface tension of the upper layer; and γ2 (mN/m) represents a static surface tension of the lower layer in contact with the upper layer.

The first aspect is for sequential multi-layer coating and satisfies the equation W/[U(γ1−γ2)]≧0.018 . . . (A1). Thus, coating defects such as poor coating, liquid repellency, and coating streak can be remarkably prevented from the beginning to the end of coating. Preferably, the coating satisfies W/[U(γ1−γ2)]≧0.02.

In order to achieve the above object, a second aspect of the present invention provides a multi-layer coating method for sequentially forming two or more layers by: applying a lower layer onto a continuously traveling web with a first coating device; and applying an upper layer on the lower layer with a second coating device while the lower layer is undried, wherein a non-contact coating system for applying an upper layer coating liquid in a non-contact state with the lower layer is used as the second coating device, and the following equations (B1), (B2) and (B3) are satisfied,

W/[U(γ1−γ2)]≧0.018 (B1)

μ1>μ2 (B2)

W(μ1−μ2)/U≧1.1 (B3)

wherein W (cc/m²) represents a wet coating amount of the upper layer; U (m/min.) represents a traveling speed of the web; γ1 (mN/m) represents a dynamic surface tension of the upper layer; γ2 (mN/m) represents a static surface tension of the lower layer in contact with the upper layer; μ1 (mPa·s) represents a liquid viscosity of the upper layer; and μ2 (mPa·s) represents a liquid viscosity of the lower layer in contact with the upper layer.

The second aspect is for sequential multi-layer coating, and satisfies: W/[U(γ1−γ2]≧0.018 . . . (B1); μ1>μ2 . . . (B2); and W(μ1−μ2)/U≧1.1 . . . (B3). Thus, coating defects such as poor coating, liquid repellency and coating streak can be further remarkably prevented. Preferably, the coating satisfies; W/[U(γ1−γ2)]≧0.02 . . . (B1); and W(μ1−μ2)/U≧2.0 . . . (B3).

To achieve the above object, a third aspect of the present invention provides a multi-layer coating method, which comprises the steps of simultaneously forming two or more layers with one coating device of a slide bead type and a slide curtain type having a slide surface on a continuously traveling web, wherein the following equation (A1) is satisfied,

W/[U(γ1−γ2)]≧0.018 (A1)

wherein W (cc/m²) represents a wet coating amount of the upper layer; U (m/min.) represents a traveling speed of the web; γ1 (mN/m) represents a dynamic surface tension of the upper layer; and γ2 (mN/m) represents a static surface tension of the lower layer in contact with the upper layer.

The third aspect is for simultaneous multi-layer coating, and satisfies W/[U(γ1−γ2)]≧0.018 . . . (A1) so as to prevent flow unevenness or liquid repellency on the slide surface. This prevents coating defects from occurring. Preferably, the coating satisfies W/[U(γ1−γ2)]≧0.02.

In order to achieve the above object, a fourth aspect of the present invention provides a multi-layer coating method, which comprises the step of simultaneously forming two or more layers with one coating device of a slide bead type and a slide curtain type having a slide surface on a continuously traveling web, wherein the following equations (B1), (B2) and (B3) are satisfied,

W/[U(γ1−γ2)]≧0.018 (B1)

μ1>μ2 (B2)

W(μ1−μ2)/U≧1.1 (B3)

wherein W (cc/m²) represents a wet coating amount of the upper layer; U (m/min.) represents a traveling speed of the web; γ1 (mN/m) represents a dynamic surface tension of the upper layer; γ2 (mN/m) represents a static surface tension of the lower layer in contact with the upper layer; μ1 (mPa·s) represents a liquid viscosity of the upper layer; and μ2 (mPa·s) represents a liquid viscosity of the lower layer in contact with the upper layer.

The fourth aspect is for simultaneous multi-layer coating, and satisfies three equations: W/[U(γ1−γ2)]≧0.018 . . . (B1); μ1>μ2 . . . (B2); and W(μ1−μ2)/U≧1.1 . . . (B3) so as to prevent flow unevenness or liquid repellency on the slide surface. This prevents coating defects from occurring. Preferably the coating satisfies W/[U(γ1−γ2)]≧0.02 and W(μ1−μ2)/U≧2.0.

A fifth aspect is featured in that the coating device for the upper layer in any one of the first to fourth aspects is any of extrusion coating, slide bead coating and slide curtain coating.

The fifth aspect indicates a preferable embodiment for a non-contact coating device for applying the upper layer.

A sixth aspect is featured in that the web has a traveling speed of 60 m/min. or more in any one of the first to fifth aspects. This is because the present invention is effective when the traveling speed of the web is 60 m/min. or more.

A seventh aspect is featured in that the layers to be applied to the web has a total coating amount of 50 cc/m² or less in a wet condition in any one of the first to sixth aspects. This is because the present invention is particularly effective in the case of thin layer coating wherein the total coating amount of the plurality of layers to be applied to the web is 50 cc/m² or less.

In order to achieve the above object, an eighth aspect of the present invention provides a method for manufacturing a planographic printing plate, which is featured by using the multi-layer coating method described in any one of the first to seventh aspects. Use of the multi-layer coating method of the present invention for the production of a planographic printing plate enables the production of a planographic printing plate with an excellent surface condition.

In order to achieve the above object, a ninth aspect provides a planographic printing plate, which is manufactured by the method of the eighth aspect for manufacturing a planographic printing plate. This enables a planographic printing plate with an excellent surface condition to be obtained.

A tenth aspect is featured in that both photosensitive layer protection lower layer and photosensitive layer protection upper layer are doubly applied in a stack as photosensitive layer protection layers after a photosensitive layer is applied and dried. The tenth aspect indicates one preferred example for lower and upper layers formed by using the multi-layer coating method for a planographic printing plate.

A eleventh aspect is featured in that pure water is used as a solvent of a photosensitive layer protection layer coating liquid so that the coating liquid is aqueous.

The present invention can provide stable coating without coating defects such as poor coating, liquid repellency and coating streak, when a plurality of layers are sequentially applied by using a non-contact coating device for an upper layer.

Further, when a plurality of layers are applied simultaneously by using a one coating device with a slide surface, the present invention can prevent coating defects such as flow unevenness and liquid repellency on the slide surface from occurring.

Furthermore, when a planographic printing plate is manufactured by the multi-layer coating method of the present invention, a high-quality planographic printing plate with an excellent surface condition can be obtained.

### BRIEF DESCRIPTION OF THE DRAWINGS

FIG. 1 is a diagram of a coating line, which incorporates a sequential multi-layer coating method according to a first embodiment of the present invention thereinto;

FIG. 2 is an explanatory view depicting a rod coating device used as a first coating device in the first embodiment;

FIG. 3 is an explanatory view depicting an extrusion coating device used as a second coating device in the first embodiment;

FIG. 4 is a diagram of a coating line, which incorporates a simultaneous multi-layer coating method according to a second embodiment of the present invention thereinto;

FIG. 5 is a side cross sectional view depicting a slide bead coating device used in the second embodiment;

FIG. 6 is a top view depicting the slide bead coating device used in the second embodiment;

FIG. 7 is a table for examples of the first embodiment of the present invention when the surface tensions of upper and lower layers of coating liquids are defined as liquid properties; and

FIG. 8 is a table for examples of the first embodiment of the present invention when the viscosity of upper and lower layers of coating liquids are defined as liquid properties.

### DETAILED DESCRIPTION OF THE PREFERRED EMBODIMENTS

Hereafter, preferred embodiment of a multi-layer coating method, and a method for manufacturing a planographic printing plate using the multi-layer coating method and a planographic printing plate according to the present invention will be described by referring to the drawings. The multi-layer coating method of the present invention will be described by using one example wherein the method is incorporated into a method for manufacturing a planographic printing plate. However, the present invention is not limited to the incorporation into planographic printing plate production, and can be applied to various production lines including multi-layer coating.

The present embodiments will be described by using an example wherein a photosensitive layer protection layer (A) L1 and a photosensitive layer protection layer (B) L2 are applied as a lower layer and an upper layer, respectively. However, the present invention is not limited to a case wherein upper and lower layers are photosensitive layer protection layers. Further, the present invention is not limited to two layers of upper and lower layers, and may be used for multi-layer coating of two or more layers. For example, in the case of three layers, an undermost layer and an intermediate layer are regarded as a lower layer and an upper layer, and further the intermediate layer and a top most layer are regarded as a lower layer and an upper layer.

### First Embodiment

In a first embodiment of a multi-layer coating method of the present invention, the photosensitive layer protection layer (A) L1 (lower side layer, which is hereafter referred to as “lower layer”) is formed by coating on a continuously traveling web with a rod coating device. Then, while the photosensitive layer protection layer (A) L1 is not dried (wet state wherein the solid content of coating liquid is 60% or less), the photosensitive layer protection layer (B) L2 (upper side layer, which is hereafter referred to as “upper layer”) is applied on the protection layer (A) L1 with an extrusion coating device (non-contact type).

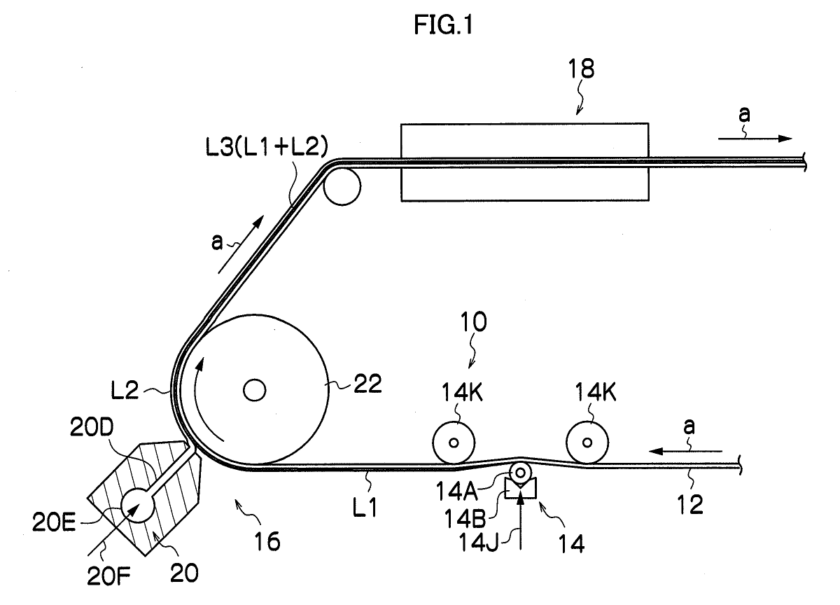

FIG. 1 shows a coating line 10, which is one embodiment for achieving the first embodiment of the multi-layer coating method of the present invention. In the coating line 10, an aluminum web 12 travels as a support for a planographic printing plate. Pretreatments such as graining and anodizing are conducted on the web 12. Thereafter, a photosensitive layer is applied with a rod coating or the like, and dried with a hot air dryer or the like, so that the photosensitive layer is formed on the aluminum support.

In this coating line 10, the web 12 is adapted to continuously travel along a fixed conveying direction indicated by arrow a, and a rod coating device 14 for applying the photosensitive layer protection layer (A) L1 (lower layer) and an extrusion coating device 16 for applying the photosensitive layer protection layer (B) L2 (upper layer) are disposed sequentially from the upstream side of the conveying direction.

The coating device for applying the upper layer is required to be a non-contact coating type, which applies a coating liquid in a non-contact state from the lower layer. In addition to the above extrusion coating device, a slide bead coating device and a slide curtain coating device, for example, are preferably used. On the other hand, the coating device for applying the lower layer is not limited to a non-contact coating type, and various publicly-known coating devices can be used. Examples thereof include a blade coater, an air knife coater, a roll coater, a bar coater, a gravure coater, a rod blade coater, a lip coater, a curtain coater, a die coater and a slide bead coater.

Further, a dryer 18 for drying a multi-coated layer L3 having the photosensitive layer protection layer (A) L1 (lower layer) and the photosensitive layer protection layer (B) L2 (upper layer) is disposed at the downstream of the extrusion coating device 16. As the dryer 18, various dryers can be used such as hot air drying type for drying the multi-coated layer L3 by hot air; infrared drying type for drying by infrared radiation; and condensation drying type having a condensation plate disposed near the multi-coated layer L3.

Next, elements of each of the rod coating device 14 and the extrusion coating device 16 are described in detail.

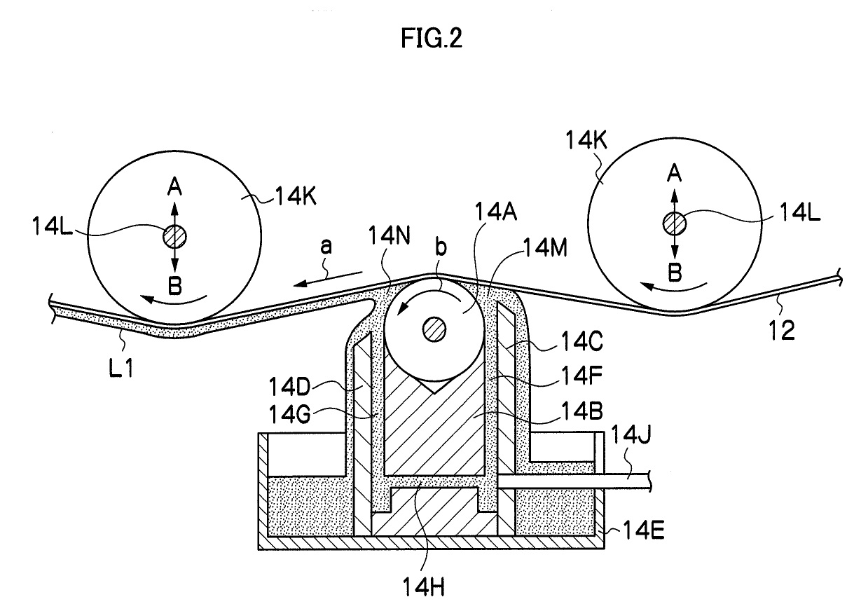

As shown in FIG. 2, the rod coating device 14 comprises: a rod 14A, which rotates in the same direction as the conveying direction a of the web 12 (that is, the direction indicated by arrow b) while contacting the web 12; a rod supporting member 14B which supports the rod 14A by a V-shaped groove formed on the top surface thereof; an upstream-side dam board 14C formed upright at the upstream side of the rod supporting member 14B; a downstream-side dam board 14D formed upright at the downstream side of the rod supporting member 14B; and a base 14E having the rod supporting member 14B, the upstream-side dam board 14C and the downstream-side dam board 14D fixed thereon.

An upstream-side liquid supplying passage 14F for supplying a photosensitive layer protection layer (A) coating liquid to the upstream side of the rod 14A is provided between the rod supporting member 14B and the upstream-side dam board 14C. A downstream-side liquid supplying passage 14G for supplying the photosensitive layer protection layer (A) coating liquid to the downstream side of the rod 14A is provided between the rod supporting member 14B and the downstream-side dam board 14D. The upstream-side liquid supplying passage 14F and the downstream-side liquid supplying passage 14G communicate with each other by a communicating passage 14H provided at a lower portion of the rod supporting member 14B. A liquid supplying pipe line 14J for supplying the photosensitive layer protection layer (A) coating liquid is connected to a lower end of the upstream-side liquid supplying passage 14F.

One pair of web pressing rollers 14K are disposed above the web 12, and the rollers press the web 12 toward the rod 14A in such a manner as to be drive to rotate around rotary shafts 14L at the time of applying the photosensitive layer protection layer (A) coating liquid. More specifically, the rotary shaft 14L of the web pressing roller 14K is slidable in a direction A-B in FIG. 2 with a sliding device (not shown).

As the rod 14A, preferably usable are: a rolling rod having grooves engraved at predetermined intervals in a circumferential direction of the rod surface by rolling processing; a wire rod having a wire closely wound on the rod surface; and the like.

The rod 14A preferably has an outer diameter of φ1 to 30 mm, more preferably φ6 to 20 mm from the viewpoint of rod rolling accuracy (straightness/circularity), rotational moment and weight balance.

The rod supporting member 14B is not limited as long as it can reliably support the rotating rod 14A. However, a rod supporting member having a low coefficient of friction with respect to the rod 14A is preferred for smooth rotation of the rod 14A, and further a rod supporting member having a high wear resistance is preferred. Materials that satisfy these conditions include a polyethylene resin, a fluorocarbon resin, a polyacetal resin, and the like. Among them, polytetrafluoro ethylene known as Teflon (tradename of DuPont in U.S.A) and polyacetal resin known as Delrin (tradename of DuPont in U.S.A) are particularly suitable in terms of coefficient of friction and strength (wear resistance). Further, materials obtained by adding a filler such as glass fiber, graphite, molybdenum disulfide or the like to the above-described plastic materials can also be used. Moreover, after the rod supporting member 14B is made of a metallic material, the above-described plastic material is applied or adhered to the surface thereof (at least a portion for supporting the rod 14A) so that the friction coefficient between the rod supporting member 14B and the rod 14A can be reduced. Alternatively, various metallic materials impregnated with the above-described plastic materials (for example, aluminum impregnated with polytetrafluoro ethylene) can also be used for the rod supporting member 14B.

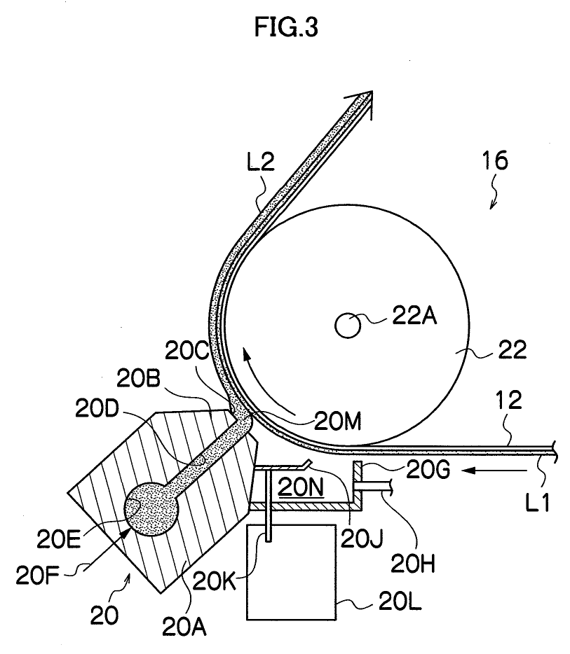

FIG. 3 shows a structure of the extrusion coating device 16.

As shown in FIG. 3, the extrusion coating device 16 mainly comprises a die coater 20 and a backup roller 22 for winding and supporting the traveling web 12. The die coater 20 has a die coater body 20A formed in a substantially rectangular parallelepiped block shape. The die coater body 20A has an end portion 20B with a wedge-shaped cross section protruding toward the backup roller 22. The end portion 20B has an end surface 20C formed at a tip thereof parallel to the direction of a rotary shaft 22A of the backup roller 22. A clearance (gap) of about 0.1 to 1 mm is usually formed between the end surface 20C and the web 12 wound around the backup roller 22. Then, a coating liquid discharged from a slit described below to the end surface 20C forms a bead 20M (liquid pool) of the coating liquid in the clearance between the web 12 and the end surface 20C, and is applied to the web 12 through this bead 20M. In this way, the extrusion coating device 16 can apply, in a non-contact state, the photosensitive layer protection layer (B) L2 (upper layer) onto the photosensitive layer protection layer (A) L1 (lower layer) that is already applied with a rod coating device 14.

Inside the die coater body 20A, a slit 20D is formed, which is a narrow passage for discharging the photosensitive layer protection layer (B) coating liquid. The slit 20D has an opening extending along the width direction of the web 12 and communicates at its lower end with a liquid supplying passage 20F via a manifold 20E. This allows the photosensitive layer protection layer (B) coating liquid supplied from the liquid supplying passage 20F to flow in an extended manner to the width direction of the web 12 at the manifold 20E and to flow through the slit 20D and be discharged from the end surface 20C.

Further, a decompression chamber 20G is provided at a lower side of the end portion 20B of the die coater body 20A, forming a decompressed space 20N enclosed by the end portion 20B of the die coater body 20A, the backup roller 22 and the decompression chamber 20G.

A decompression tube 20H for decompressing the inside of the decompression chamber 20G is connected to the side face of the decompression chamber 20G. This enables the decompressed space 20N to be decompressed, so that the upstream of the above-mentioned bead 20M can be decompressed and the bead 20M can be stably formed.

Inside the decompression chamber 20G, a gutter-shaped excess liquid receiver 20J is provided for receiving an excess the photosensitive layer protection layer (B) coating liquid discharged from the slit 20D, which has not been applied to the web 12. The excess liquid receiver 20J is connected to a reservoir 20L via a drainage tube 20K.

Next, the multi-layer coating method of the present invention will be described by referring to the above-described coating line 10 of FIG. 1.

First, a surface of the web 12 that has been pre-treated by graining, anodizing and the like is coated with a photosensitive layer with a rod coating device or the like, and dried using a hot air drying system. Then, the coating film surface of the applied and dried photosensitive layer is coated with the photosensitive layer protection layer (A) coating liquid with the rod coating device 14. In other words, the photosensitive layer-coated web 12 is brought into contact with the rod 14A, and the photosensitive layer protection layer (A) coating liquid is supplied to the upstream-side liquid supplying passage 14F and the downstream-side liquid supplying passage 14G. This allows a first liquid pool 14M of the coating liquid to be formed at the upstream side of the contact between the web 12 and the rod 14A, and at the same time allows a second liquid pool 14N to be formed at the downstream side thereof. The rotating rod 14A scoops up the photosensitive layer protection layer (A) coating liquid from these liquid pools 14M and 14N and transfers the liquid to the web 12, so that the web 12 is coated with the photosensitive layer protection layer (A) coating liquid with a predetermined thickness. Consequently, the photosensitive layer protection layer (A) L1 is formed as the lower layer on the web 12.

Next, while the web 12 having the photosensitive layer protection layer (A) L1 formed thereon is not dried, the web travels to the extrusion coating device 16 so that the photosensitive layer protection layer (B) L2 is applied onto the photosensitive layer protection layer (A) L1. More specifically, the photosensitive layer protection layer (B) coating liquid is discharged from the slit 20D of the die coater body 20A, and at the same time the inside of the decompression chamber 20G is decompressed to from 50 to 1000 Pa·s. Then, the bead 20M is formed between the end surface 20C of the die coater body 20A and the photosensitive layer protection layer (A) L1 applied onto the web 12, and the photosensitive layer protection layer (B) L2 is applied onto the undried photosensitive layer protection layer (A) L1 through the bead 20M (so-called wet-on-wet coating is performed). The multi-coated layer L3 obtained by sequential multi-layer coating of the photosensitive layer protection layer (A) L1 and the photosensitive layer protection layer (B) L2 is dried by the dryer 18, and then is wound by a winding device (not shown). Consequently, a planographic printing plate is manufactured.

In the above sequential multi-layer coating, the coating is conducted so as to satisfy any of the following [A] and [B].

[A] When W (cc/m²) represents a wet coating amount of the photosensitive layer protection layer (B) L2 (upper layer); U (m/min.) represents a traveling speed of the web 12; γ1 (mN/m) represents a dynamic surface tension of the photosensitive layer protection layer (B) L2 (upper layer); and γ2 (mN/m) represents a static surface tension of the photosensitive layer protection layer (A) L1 (lower layer), the following equation (A1) is satisfied.

W/[U(γ1−γ2)]≧0.018 (preferably 0.02) (A1)

[B] When W (cc/m²) represents a wet coating amount of the photosensitive layer protection layer (B) L2 (upper layer); U (m/min.) represents a traveling speed of the web 12; γ1 (mN/m) represents a dynamic surface tension of the photosensitive layer protection layer (B) L2 (upper layer); and γ2 (mN/m) represents a static surface tension of the photosensitive layer protection layer (A) L1 (lower layer); μ1 (mPa·s) represents a liquid viscosity of the photosensitive layer protection layer (B) L2 (upper layer); and 12 (mPa·s) represents a liquid viscosity of the photosensitive layer protection layer (A) L1 (lower layer), the following equations (B1), (B2) and (B3) are satisfied.

W/[U(γ1−γ2)]≧0.018 (preferably 0.02) (B1)

μ1>μ2 (B2)

W(μ1−μ2)/U≧1.1 (preferably 2.0) (B3)

In this manner, the sequential multi-layer coating is conducted so as to satisfy any of the above [A] and [B], and thereby stable coating can be conducted with no coating defects such as poor application wherein the photosensitive layer protection layer (B) L2 is poorly applied onto the photosensitive layer protection layer (A) L1; liquid repellency wherein the photosensitive layer protection layer (B) L2 is rejected by the photosensitive layer protection layer (A) L1; and coating streak on the surface of the manufactured planographic printing plate.

### Second Embodiment

In a second embodiment of the multi-layer coating method of the present invention, a photosensitive layer protection layer (A) L1 (lower layer) and a photosensitive layer protection layer (B) L2 (upper layer) are simultaneously applied onto a continuously traveling web 12 with one a slide bead coating device having a slide surface. Hereafter, like reference numerals refer to like members and devices of the first embodiment.

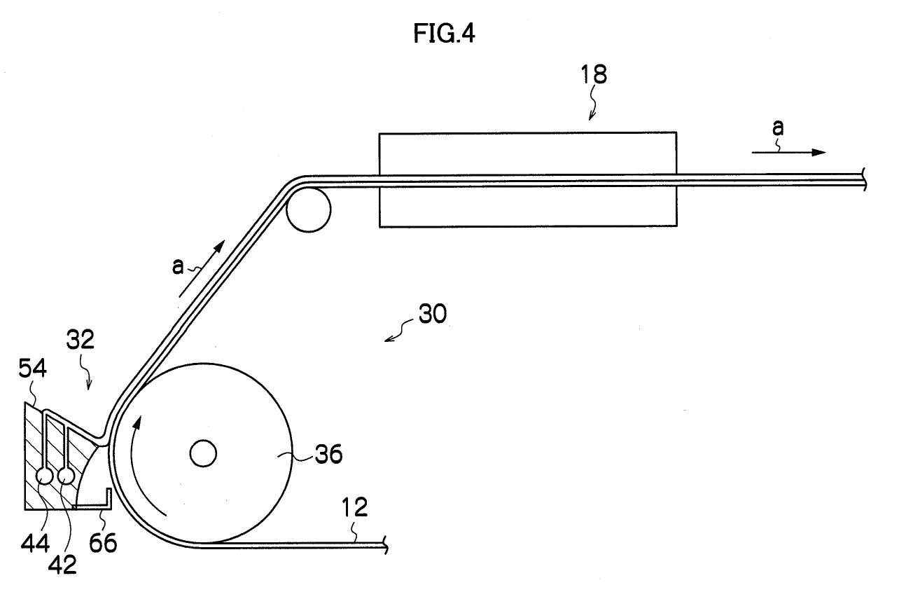

FIG. 4 shows a coating line 30, which is one embodiment for achieving the second embodiment of the multi-layer coating method of the present invention. In the coating line 30, the web 12 travels as a support for a planographic printing plate. Pretreatments such as graining and anodizing are conducted on the web 12. Thereafter, a photosensitive layer is applied with a rod coating or the like, and dried with a hot air dryer or the like, so that the photosensitive layer is formed on the aluminum support.

In this coating line 30, the web 12 is adapted to continuously travel along a fixed conveying direction indicated by arrow a. On this traveling path, a slide bead coating device 32 is disposed for simultaneous multi-layer coating of the photosensitive layer protection layer (A) L1 (lower layer) and the photosensitive layer protection layer (B) L2 (upper layer). As a coating device provided with a slide surface, known slide curtain coating devices can be used in addition to a slide bead coating device. Further, a dryer 18 disposed at the downstream of the slide bead coating device 32 is the same as in the first embodiment, and thus its description is omitted.

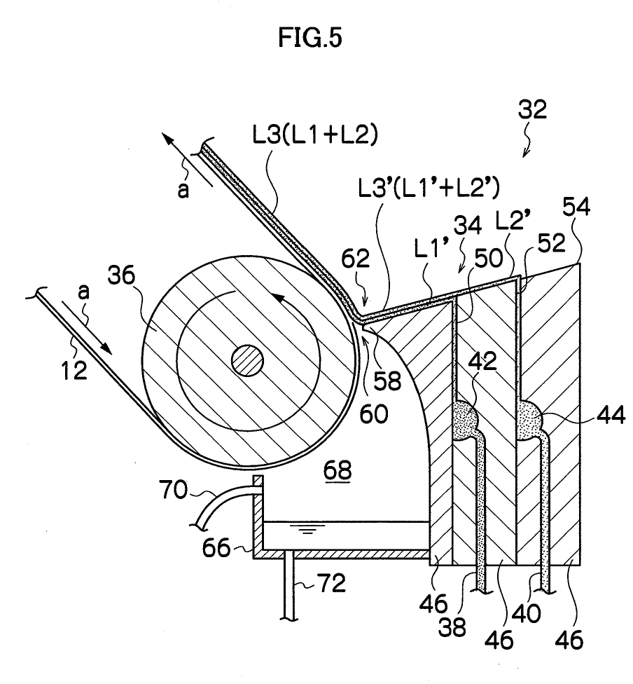

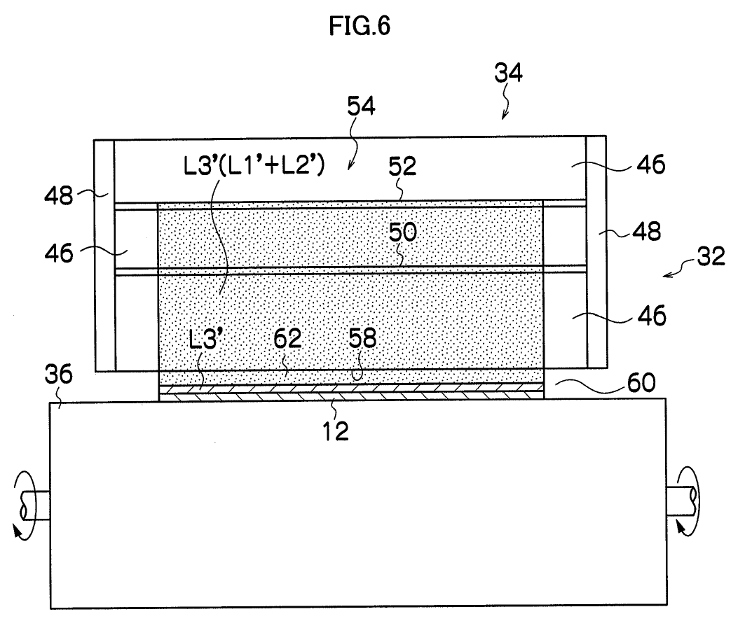

As shown in FIGS. 5 and 6, the slide bead coating device 32 mainly comprises a slide hopper body 34 and a backup roller 36 for winding and supporting the web 12. A photosensitive layer protection layer (A) coating liquid and a photosensitive layer protection layer (B) coating liquid to be applied to the web 12 are supplied from coating liquid tanks (not shown) to manifolds 42, 44 inside the slide hopper body 34 via supply lines 38, 40, respectively. The slide hopper body 34 mainly comprises a plurality of die blocks 46, 46, a pair of side plates 48 that abut against the side faces of the die blocks 46 while the die blocks are coupled with each other (see FIG. 6). Within the slide hopper body 34, passages for flowing coating liquids L1′ and L2′ (photosensitive layer protection layer (A) coating liquid and a photosensitive layer protection layer (B) coating liquid) are formed, which comprises supply tubes 38, 40, manifolds 42, 44, slits 50, 52, and a slide surface 54. The coating liquids L1′ and L2′ supplied to the manifolds 42, 44 are flown in an extended manner to the coating width direction and extruded to the slide surface 54 that downwardly tilts on the top surface of the slide hopper body 34, via the slits 50 and 52, respectively. The coating liquids L1′ and L2′ extruded to the slide surface 54 flows down on the slide surface 54 as a multi-layered liquid L3′ without mixing with each other, and reach to a lip end 58 at the lower end of the slide surface 54. The multi-layered liquid L3′ forms a bead 62 (liquid pool) of the multi-layered liquid L3′ in a clearance (gap) 60 between the lip end 58 and the web 12 that travels while being wound and supported by the backup roller 36, and the liquid is applied to the web 12 via the bead 62. This enables the formation of a multi-layer L3 obtained by simultaneous multi-layer coating of the photosensitive layer protection layer (A) L1 (lower layer) and the photosensitive layer protection layer (B) L2 (upper layer).

Further, a decompression chamber 66 is provided at a lower side of the lip end 58 of the slide hopper body 34, forming a decompressed space 68 enclosed by the slide hopper body 34, the backup roller 36 and the decompression chamber 66. The decompression chamber 66 is connected at the side face thereof to an exhaust tube 70 connected to a vacuum device (not shown), and at the bottom face to a drainage tube 72 for discharging the multi-layered liquid L3′ that has dropped inside the decompression chamber 66. The decompression chamber 66 enables the upstream side of the bead 62 (lower side in FIG. 5) to have a negative pressure to stabilize the bead 62. The decompressed space 68 within the decompression chamber 66 is preferably decompressed in the range of 50 to 1000 Pa·s.

In the above simultaneous multi-layer coating of the second embodiment, the coating is conducted so as to satisfy any of the following [A] and [B].

[A] When W (cc/m²) represents a wet coating amount of the photosensitive layer protection layer (B) L2 (upper layer); U (m/min.) represents a traveling speed of the web 12; γ1 (mN/m) represents a dynamic surface tension of the photosensitive layer protection layer (B) L2 (upper layer); and γ2 (mN/m) represents a static surface tension of the photosensitive layer protection layer (A) L1 (lower layer), the following equation (A1) is satisfied.

W/[U(γ1−γ2)]≧0.018 (preferably 0.02) (A1)

[B] When W (cc/m²) represents a wet coating amount of the photosensitive layer protection layer (B) L2 (upper layer); U (m/min.) represents a traveling speed of the web 12; γ1 (mN/m) represents a dynamic surface tension of the photosensitive layer protection layer (B) L2 (upper layer); and γ2 (mN/m) represents a static surface tension of the photosensitive layer protection layer (A) L1 (lower layer); μ1 (mPa·s) represents a liquid viscosity of the photosensitive layer protection layer (B) L2 (upper layer); and μ2 (mPa·s) represents a liquid viscosity of the photosensitive layer protection layer (A) L1 (lower layer), the following equations (B1), (B2) and (B3) are satisfied.

W/[U(γ1−γ2)]≧0.018 (preferably 0.02) (B1)

μ1>μ2 (B2)

W(μ1−μ2)/U≧1.1 (preferably 2.0) (B3)

In this manner, the simultaneous multi-layer coating is conducted so as to satisfy any of the above [A] and [B]. This prevents coating defects such as flow unevenness and liquid repellency on the slide surface from occurring in the case of simultaneous multi-layer coating of a plurality of layers using a coater having a slide surface.

Further, the web 12 to be used in the present invention may be in the form of strip or sheet. The web may be made of a thin-plate metal such as aluminum (the above-described aluminum web 12), paper, a plastic film, resin-coated paper, synthetic paper or the like. When an aluminum plate is used as the web 12, for example, JIS 1050 material, JIS 1100 material, JIS 1070 material, Al—Mg based alloy, Al—Mn based alloy, Al—Mn—Mg based alloy, Al—Zr based alloy, Al—Mg—Si based alloy, and the like are applicable. Exemplary materials of the plastic film to be used include: polyolefins such as polyethylene and polypropylene; vinyl polymers such as polyvinyl acetate, polyvinyl chloride and polystyrene; polyamides such as 6,6-nylon and 6-nylon; polyesters such as polyethylene terephthalate and polyethylene-2,6-naphthalate; cellulose acetates such as polycarbonate, cellulose triacetate and cellulose diacetate. Further, a typical resin used for the resin-coated paper is polyolefin such as polyethylene, but the present invention is not limited thereto.

The thickness of the web 12 is not particularly limited, but the web having a thickness of about 0.01 mm to 1.0 mm is advantageous in terms of handling or versatility.

Further, as the photosensitive-layer coating liquid to be coated and dried in advance on the web 12, an aqueous solution of a high polymer compound, an organic solvent solution, a pigment dispersion, a colloidal solution or the like can be used. Examples of the photosensitive-layer coating liquid used to form a photosensitive layer of a planographic printing plate includes photosensitive solutions that can form photosensitive layers having the following aspects (1) to (11):

(1) a photosensitive layer containing an infrared ray absorbent, a compound which produces an acid by heat, and a compound which is cross-linked by addition of an acid;

(2) a photosensitive layer containing an infrared ray absorbent, and a compound which becomes alkali-soluble by heat;

(3) a photosensitive layer having two layers: a layer containing a compound which generates a radial by irradiation of laser light, a binder soluble in alkali, and a multifunctional monomer or prepolymer; and an oxygen blocking layer;

(4) a photosensitive layer having two layers: a physical development center layer; and a silver halide emulsion layer;

(5) a photosensitive layer having three layers: a polymer layer including a multifunctional monomer and a multifunctional binder; a layer including silver halide and a reducing agent; and an oxygen blocking layer;

(6) a photosensitive layer having two layers: a layer including a novolak resin and naphthoquinone diazide; and a layer including silver halide;

(7) a photosensitive layer containing an organic photoconductor;

(8) a photosensitive layer having two to three layers: a laser light absorption layer removed by irradiation of laser light; and a lipophilic layer and/or a hydrophilic layer;

(9) a photosensitive layer containing a compound which generates an acid by energy absorption, a high polymer compound having a functional group which generates sulfonic acid or carboxylic acid by addition of an acid, at a side chain, and a compound which imparts energy to an acid generator by visible light absorption;

(10) a photosensitive layer containing a quinone diazide compound and a novolak resin;

(11) a photosensitive layer containing a compound which is decomposed by light or ultraviolet radiation to form a cross-linking structure with itself or other molecules in the layer, and a binder soluble in an alkali.

### Example 1

Next, an example for manufacturing a planographic printing plate by using a coating line 10 described in the first embodiment of the present invention will be described, but the present invention is not limited thereto.

### 1. Preparation of Support (Web 12)

A JIS-A1050 strip-shaped aluminum plate having a thickness of 0.30 mm and a width of 1,030 mm was subjected to surface treatment described below, and photosensitive layer coating liquid coated then dried, so that a surface-treated support (web 12) with a photosensitive layer dried was obtained.

### <Surface Treatment>

The surface treatment was carried out by continuously conducting the following processes (a) to (f). After each process and water washing, liquid removal was conducted with a nip roller.

(a) The aluminum plate was etched in an aqueous solution containing 26% by weight of caustic soda and 6.5% by weight of aluminum ions at 70° C. so that 5 g/m² of aluminum plate was dissolved. The etched plate was then washed with water.

(b) The aluminum plate was desmutted by spraying a 1% by weight of nitric acid aqueous solution (containing 0.5% by weight of aluminum ions) at 30° C. to the aluminum plate. Then, the aluminum plate was washed with water.

(c) The surface of the aluminum plate was continuously electrochemically roughened by applying an alternate current voltage having a frequency of 60 Hz to the aluminum plate. An electrolyte used at this time was a 1% by weight of nitric acid aqueous solution (containing 0.5% by weight of aluminum ions and 0.007% by weight of ammonium ions) with a temperature of 30° C. The applied alternate current source had a time (TP) of 2 msec for permitting a current value to reach to a peak from zero, a duty ratio of 1:1, and a trapezoidal waveform. In the electrochemical roughening treatment, a carbon electrode was used as a counter electrode. An auxiliary anode formed of ferrite was used. The electric current density was 25 A/dm² at the peak of electric current. The applied electric quantity was 250 C/cm² as the total of electric quantity at the time when the aluminum plate served as an anode. A part (5%) of the current supplied from current source was diverted to the auxiliary anode. Then, the aluminum plate was washed with water.

(d) The aluminum plate was etched by spraying an aqueous solution containing 26% by weight of caustic soda and 6.5% by weight of aluminum ions to the aluminum plate at 35° C. so that 0.2 g/m² of aluminum plate was dissolved. Then, smut components mainly composed of aluminum hydroxide which were generated during the electrochemical surface roughening by using the alternate current were removed, and edge portions of pits were dissolved so that the edge portions were smoothened. Then, water washing was conducted.

(e) The aluminum plate was desmutted by spraying a 25% by weight of sulfuric acid aqueous solution (containing 0.5% by weight of aluminum ions) at 60° C. to the aluminum plate. Then, water washing was conducted by spraying of water.

(f) The aluminum plate was anodized in a 170 g/L of sulfuric acid aqueous solution (containing 0.5% by weight of aluminum ions) at a temperature of 33° C. and an electric density of 5 A/dm² for 50 seconds. Then, the aluminum plate was washed with water. At this time, the weight of the anodized film was 2.7 g/m².

The thus obtained aluminum support had a surface roughness (Ra) of 0.27 (measured with SURFCOM manufactured by Tokyo Seimitsu Co. Ltd., having a stylus with a distal diameter of 2 μm).

### <Backcoat Layer>

Next, the following undercoat layer coating liquid was applied to the rear surface of the aluminum support with a wire bar, and dried at 100° C. for 10 seconds. The coating amount was 0.5 g/m².

### (Backcoat Layer Coating Liquid)

| | | |
|---|---|---|
| PR55422 (Sumitomo Bakelite Co., Ltd.) | 0.44 | g |
| (phenol/m-cresol/p-cresol = 5/3/2, average | | |
| molecular weight: 5300) | | |
| Fluorinated surfactant | 0.002 | g |
| (MEGAFACE F-780-F manufactured by Dainippoin | | |
| Ink and Chemicals, Inc., 30% by weight methyl | | |
| isobutyl ketone (MIBK) solution) | | |
| Methanol | 3.70 | g |
| 1-methoxy-2-propanol | 0.92 | g |

### <Undercoat Layer>

Next, the following undercoat layer coating liquid was applied to the top surface of the aluminum support with a wire bar, and dried at 100° C. for 10 seconds. The coating amount was 10 mg/m².

### (Undercoat Layer Coating Liquid)

| | |
|---|---|
| High polymer compound having the following structure | 0.05 g |
| [formula 1] | |
| (weight average molecular weight: 10,000) | |
| [Formula 1] | |
| 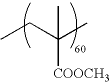 | |
| 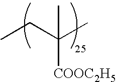 | |
| 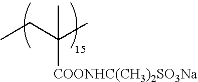 | |
| Methanol | 27 g |
| Ion exchange water | 3 g |

### <Photosensitive Layer>

On top of that, a highly sensitive photopolymerizable composition P-1 having the following composition was applied with a rod coating device, and dried with a hot air at 125° C. for 34 seconds so that the dried coating amount was 1.4 g/m², forming a photosensitive layer.

(Photopolymerizable compound P-1)

| | | |
|---|---|---|
| Infrared ray absorbent ([formula 2]) | 0.038 | g |
| Polymerization initiator A ([formula 3]) | 0.061 | g |
| Polymerization initiator B ([formula 5]) | 0.094 | g |
| Mercapto compound ([E1 to E4 of formula 4]) | 0.015 | g |
| Polymerizable compound ([formula 6]) | 0.425 | g |
| Binder polymer A ([formula 7]) | 0.311 | g |
| Binder polymer B ([formula 8]) | 0.250 | g |
| Binder polymer C ([formula 9]) | 0.062 | g |
| Additive ([formula 10]) | 0.079 | g |
| Polymerization inhibitor ([formula 11]) | 0.0012 | g |
| Ethyl violet ([formula 12]) | 0.021 | g |
| Fluorinated surfactant | 0.0081 | g |

(MEGAFACE F-780-F manufactured by Dainippoin Ink and Chemicals, Inc., 30% by weight methyl isobutyl ketone (MIBK) solution)

| | |
|---|---|
| Methyl ethyl ketone | 5.886 g |
| Methanol | 2.733 g |
| 1-methoxy-2-propanol | 5.886 g |

[Formula 2]

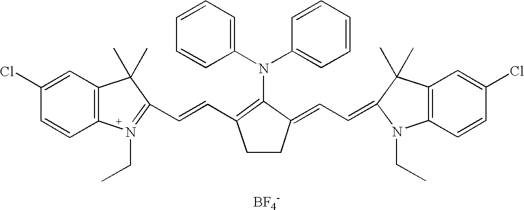

[Formula 3]

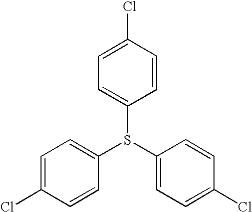

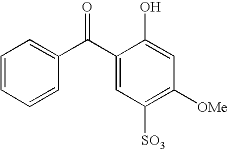

[Formula 4]

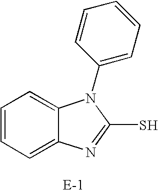

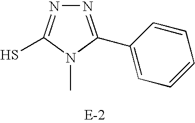

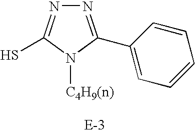

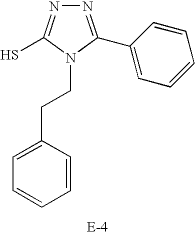

[Formula 5]

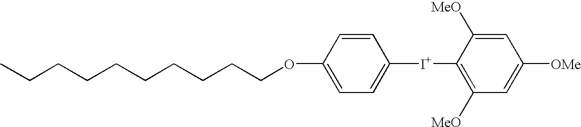

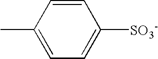

[Formula 6]

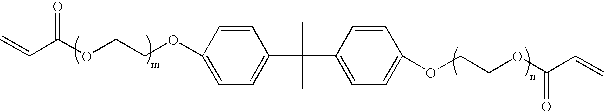

[Formula 7]

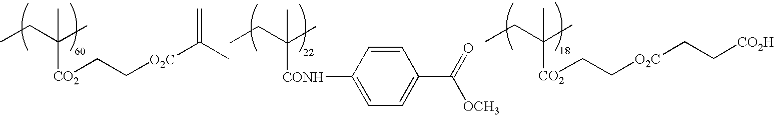

[Formula 8]

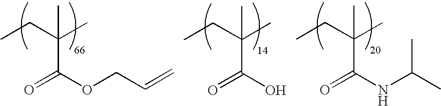

[Formula 9]

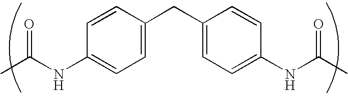

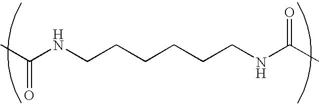

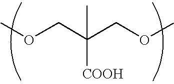

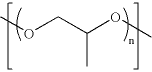

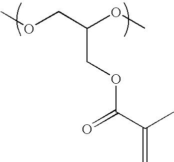

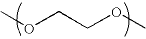

[Formula 10]

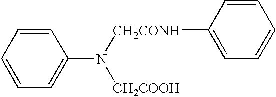

[Formula 11]

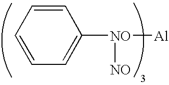

[Formula 12]

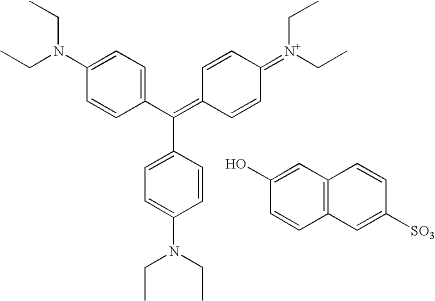

2. Coating of photosensitive layer protection layer (A) L1 (lower layer) and photosensitive layer protection layer (B) L2 (upper layer)

A photosensitive layer protection layer (A1) L1 (lower layer) was applied onto the web 12 obtained in the above Example 1 with a rod coating device 14. While the photosensitive layer protection layer (A1) L1 is not dried, a photosensitive layer protection layer (B) L2 (upper layer) was sequentially and multilayeredly applied using an extrusion coating device 16 of non-contact coating type. Then, a multi-layer L3 obtained by multi-coating of the photosensitive layer protection layer (A1) L1 and the photosensitive layer protection layer (B) L2 was dried with a dryer 18, thereby producing a planographic printing plate.

### <Photosensitive Layer Protection Layer (A) Lower Layer (L1)>

An aqueous mixture solution (coating liquid for protection layer) containing a synthetic mica (SIMASIF MEB-3L, 3.2% aqueous dispersion, manufactured by CO-OP Chemical Co., Ltd.), a polyvinylalcohol (GOHSELAN CKS-50: sulfonic acid-modified polyvinylalcohol having a saponification value of 99 mole % and a polymerization degree of 300, manufactured by Nippon Synthetic Chemical Industry Co., Ltd.), a surfactant A (EMALEX 710 manufactured by Nihon-Emulsion Co., Ltd.), and a surfactant B (ADEKA PLURONIC P-84 manufactured by Adeka Corporation) was applied to the web with a rod coating device 14 so that the wet coating amount W of the coating liquid was 15 (cc/m²).

The content ratio of synthetic mica (solid content)/polyvinylalcohol/surfactant A/surfactant B in the aqueous mixture solution (coating liquid for protection layer) was 7.5/89/2/1.5 (% by weight). The coating amount (after drying) was 0.5 g/m².

### <Photosensitive Layer Protection Layer (B) Upper Layer (L2)>

While the photosensitive layer protection layer (A) is not dried (in a wet condition), an aqueous mixture solution (protection layer coating liquid) containing an organic filler (ART PEARL J-7P manufactured by Negami Chemical Industrial Co., Ltd.), a synthetic mica (SIMASIF MEB-3L, 3.2% aqueous dispersion, manufactured by CO-OP Chemical Co., Ltd.), a polyvinylalcohol (L-3266: sulfonic acid-modified polyvinylalcohol having a saponification value of 87 mole % and a polymerization degree of 300, manufactured by Nippon Synthetic Chemical Industry Co., Ltd.), a thickening agent (CELLOGEN FS-B manufactured by Dai-ichi Kogyo Seiyaku Co., Ltd.), a high polymer compound A, and a surfactant (EMALEX 710 manufactured by Nihon-Emulsion Co., Ltd.) was applied onto the surface of the photosensitive layer protection layer (A) with an extrusion coating device 16 so that the wet coating amount of the photosensitive layer protection layer (B) was 35 (cc/m²). At this time, the clearance between the end surface 20C of the die coater body 20A and the photosensitive layer protection layer (A) L1 applied on the web 12 was 0.25 mm and the decompression chamber had a decompression degree of 200 Pa·s.

The content ratio of organic filler/synthetic mica (solid content)/polyvinylalcohol/thickening agent/high polymer compound A/surfactant in this aqueous mixture solution (protection layer coating liquid) was 4.712.8167.4/18.6/2.314.2 (% by weight). The coating amount (after drying) was 1.2 g/m².

### <Drying of Photosensitive Layer Protection Layer (A/B)>

The multi-coated layer L3 obtained by multi-coating of the photosensitive layer protection layer (A) L1 and the photosensitive layer protection layer (B) L2 was dried with the hot air dryer 18 at a temperature of 125° C. and a wind speed of 7.0 m/sec for about 20 seconds.

Planographic printing plates were manufactured so that the equation (A1) of the present invention is satisfied and not satisfied when the coating speed (line speed) was increased to three stages of 60, 80 and 120 (m/min). W/[U(γ1−γ2)]≧0.018 (preferably 0.02) . . . (A1)

Then, the manufactured planographic printing plates were examined to find how different they are in the surface condition. Surface condition evaluations are as follows.

When repelling, coating streak, coating unevenness and coating defects do not occur for a long time period (30 minutes or more), the surface condition is regarded good. When coating is completed but liquid repelling, liquid film breaking, coating streak or coating unevenness occurs over time, the surface condition is regarded fair. When repelling, coating streak, coating unevenness or a coating defect occurs, the surface condition is regarded poor.

The dynamic surface tension of the coating liquid was measured with BP-D3 manufactured by Kyowa Interface Science Co., Ltd. and the static surface tension was measured with CBVP-Z manufactured by Kyowa Interface Science Co., Ltd. at a room temperature of 25° C.

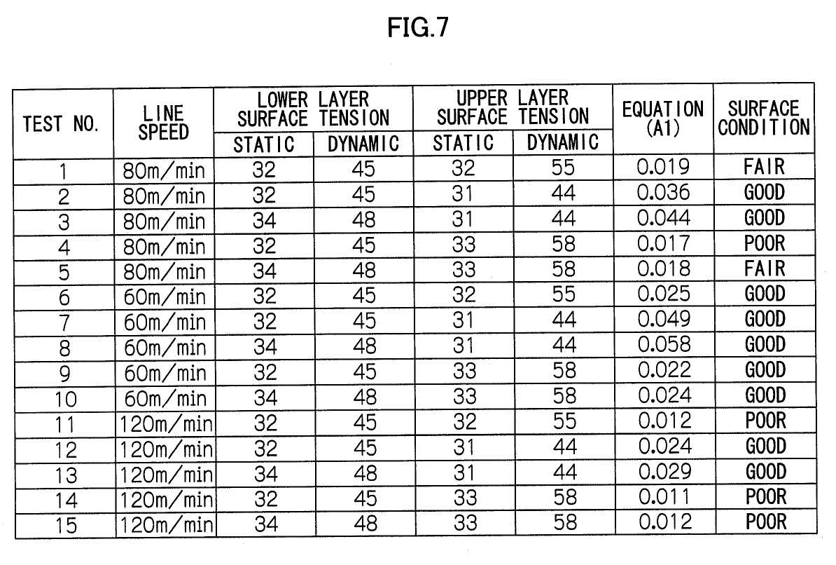

Results are shown in FIG. 7. In FIG. 7, the numerical values in the item “Equation (A1)” were calculated by substituting necessary numerical values into Equation (A1).

FIG. 7 shows that, regarding Test Nos. 4, 11, 14 and 15 that did not have the calculated value of Equation (A1) of 0.018 or more, the manufactured planographic printing plates had poor surface conditions and thus their product qualities were dissatisfactory.

In contrast, regarding Test Nos. 1 to 3, 5 to 10 and 12 to 13 that had the calculated value of Equation (A1) of 0.018 or more, the manufactured planographic printing plates had fair or good surface conditions and thus their product qualities were satisfactory. Particularly, regarding Test Nos. 2, 3, 6 to 10, 12 and 13 that had the calculated value of Equation (A1) of 0.02 or more, all of them were regarded good and they had good surface conditions.

### Example 2

Example 2 was conducted in the same manner as Example 1 in terms of the planographic printing plate manufacturing method, the conditions for a rod coating device and an extrusion coating device, the compositions of photosensitive layer protection layers L1 and L2, and the evaluation standard for surface condition of a manufactured planographic printing plate.

Planographic printing plates were manufactured so that the equations (B1), (B2), (B3) of the present invention are satisfied and not satisfied when the coating speed (line speed) was increased to three stages of 60, 80 and 120 (m/min).

W/[U(γ1−γ2)]≧0.018 (preferably 0.02) (B1)

μ1>μ2 (B2)

W(μ1−μ2)/U≧1.1 (preferably 2.0) (B3)

Then, the manufactured planographic printing plates were examined to find how different they are in the surface condition. The viscosity of the coating liquid was measured at room temperature (25° C.) using a B-type viscometer.

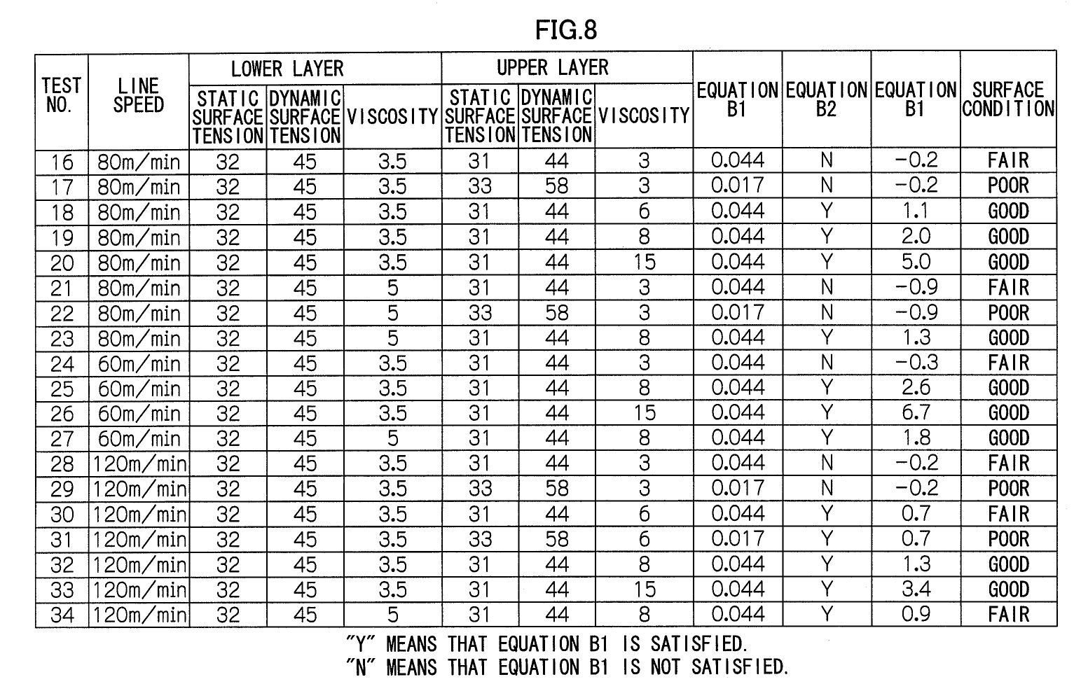

Results are shown in FIG. 8. In FIG. 8, the numerical values in the items “Equation (B1)”, “Equation (B2)” and “Equation (B3)” were calculated by substituting necessary numerical values into the these equations. In Equation (B2), “Y” means that the equation is satisfied and “N” means that the equation is not satisfied.

FIG. 8 shows that, regarding Test Nos. 16, 17, 21, 22, 24, 28, 29, 30, 31 and 34 that did not satisfy the Equations (B1), (B2) and (B3), their surface conditions were evaluated poor or fair and thus a high-quality planographic printing plate was not obtained.

In contrast, regarding Test Nos. 18, 19, 20, 23, 25, 26, 27, 32 and 33, their surface conditions were good and thus high-quality planographic printing plates were obtained.

What is claimed is:

1. A multi-layer coating method for sequentially forming two or more layers, comprising the steps of:
applying a lower layer onto a continuously traveling web with a first coating device; and
applying an upper layer on the lower layer with a second coating device while the lower layer is undried,
wherein a non-contact coating system for applying an upper layer coating liquid in a non-contact state with the lower layer is used as the second coating device(16), and the following equation (A1) is satisfied,
W/[U(γ1−γ2)]≧0.018 (A1)
wherein W (cc/m²) represents a wet coating amount of the upper layer; U (m/min.) represents a traveling speed of the web; γ1 (mN/m) represents a dynamic surface tension of the upper layer; and γ2 (mN/m) represents a static surface tension of the lower layer in contact with the upper layer.

2. A multi-layer coating method for sequentially forming two or more layers, comprising the steps of:
applying a lower layer onto a continuously traveling web with a first coating device; and
applying an upper layer on the lower layer with a second coating device while the lower layer is undried,
wherein a non-contact coating system for applying an upper layer coating liquid in a non-contact state with the lower layer is used as the second coating device, and the following equations (B1), (B2) and (B3) are satisfied,
W/[U(γ1−γ2)]≧0.018 (B1)
μ1>μ2 (B2)
W(μ1−μ2)/U≧1.1 (B3)
wherein W (cc/m²) represents a wet coating amount of the upper layer; U (m/min.) represents a traveling speed of the web; γ1 (mN/m) represents a dynamic surface tension of the upper layer; γ2 (mN/m) represents a static surface tension of the lower layer in contact with the upper layer; μ1 (mPa·s) represents a liquid viscosity of the upper layer;
and μ2 (mPa·s) represents a liquid viscosity of the lower layer in contact with the upper layer.

3. A multi-layer coating method comprising the step of simultaneously forming two or more layers with one coating device of a slide bead type and a slide curtain type having a slide surface on a continuously traveling web,
wherein the following equation (A1) is satisfied,
W/[U(γ1−γ2)]≧0.018 (A1)
wherein W (cc/m²) represents a wet coating amount of the upper layer; U (m/min.) represents a traveling speed of the web; γ1 (mN/m) represents a dynamic surface tension of the upper layer; and γ2 (mN/m) represents a static surface tension of the lower layer in contact with the upper layer.

4. A multi-layer coating method comprising the step of simultaneously forming two or more layers with one coating device of a slide bead type and a slide curtain type having a slide surface on a continuously traveling web,
wherein the following equations (B1), (B2) and (B3) are satisfied,
W/[U(γ1−γ2)]≧0.018 (B1)
μ1>μ2 (B2)
W(μ1−μ2)/U≧1.1 (B3)
wherein W (cc/m²) represents a wet coating amount of the upper layer; U (m/min.) represents a traveling speed of the web; γ1 (mN/m) represents a dynamic surface tension of the upper layer; γ2 (mN/m) represents a static surface tension of the lower layer in contact with the upper layer; μ1 (mPa·s) represents a liquid viscosity of the upper layer; and μ2 (mPa·s) represents a liquid viscosity of the lower layer in contact with the upper layer.

5. The multi-layer coating method according to claim 1, wherein the second coating device is any of extrusion coating, slide bead coating and slide curtain coating.

6. The multi-layer coating method according to claim 2, wherein the second coating device is any of extrusion coating, slide bead coating and slide curtain coating.

7. The multi-layer coating method according to claim 1, wherein the web has a traveling speed of 60 m/min. or more.

8. The multi-layer coating method according to claim 2, wherein the web has a traveling speed of 60 m/min. or more.

9. The multi-layer coating method according to claim 3, wherein the web has a traveling speed of 60 m/min. or more.

10. The multi-layer coating method according to claim 4, wherein the web has a traveling speed of 60 m/min. or more.

11. The multi-layer coating method according to claim 5, wherein the web has a traveling speed of 60 m/min. or more.

12. The multi-layer coating method according to claim 6, wherein the web has a traveling speed of 60 m/min. or more.

13. The multi-layer coating method according to claim 1, wherein the layers to be applied to the web has a total coating amount of 50 cc/m² or less in a wet condition.

14. The multi-layer coating method according to claim 2, wherein the layers to be applied to the web has a total coating amount of 50 cc/m² or less in a wet condition.

15. The multi-layer coating method according to claim 3, wherein the layers to be applied to the web has a total coating amount of 50 cc/m² or less in a wet condition.

16. The multi-layer coating method according to claim 4, wherein the layers to be applied to the web has a total coating amount of 50 cc/m² or less in a wet condition.

17. A method of manufacturing a planographic printing plate using the multi-layer coating method as recited in claim 1.

18. A planographic printing plate manufactured by the planographic printing plate manufacturing method of claim 17.

19. The planographic printing plate according to claim 18, wherein both upper and lower layers are photosensitive layer protection layers.

20. The planographic printing plate according to claim 19, wherein pure water is used as a solvent of a photosensitive layer protection layer coating liquid so that the coating liquid is aqueous.
